(19) United States
(12) Patent Application Publication
(10) Pub. No.: US 2021/0073648 A1
(43) Pub. Date: Mar. 11, 2021

(54) TECHNIQUES FOR SEMI-SUPERVISED TRAINING AND ASSOCIATED APPLICATIONS

(71) Applicant: AI Therapeutics, Inc., Guilford, CT (US)

(72) Inventors: Henri Lichenstein, Guilford, CT (US); Bradley Robert Parry, Branford, CT (US); Jonathan M. Rothberg, Guilford, CT (US); Tian Xu, Guilford, CT (US)

(21) Appl. No.: 17/011,953

(22) Filed: Sep. 3, 2020

Related U.S. Application Data
(60) Provisional application No. 62/898,498, filed on Sep. 10, 2019.

(51) Int. Cl. G06N 3/08; G06N 3/04

(52) U.S. Cl. CPC G06N 3/088; G06K 9/6256; G06N 3/0454

(57) ABSTRACT

Described herein are semi-supervised machine learning techniques and associated computer-implemented applications. Some aspects provide a system configured to identify associations among data input to the system. In some embodiments, the system may map the input data to one or more vector spaces, such that associated groups of the input data form associated clusters in the vector space(s). For example, the mapping may be performed by one or more trained encoders (e.g., neural network encoders) of the system. Accordingly, a distance separating two data entries in a space may indicate a likelihood of association among the data entries. Various applications of such systems are described herein.

### CROSS REFERENCE TO RELATED APPLICATIONS

This application claims priority under 35 U.S.C. § 119(e) to U.S. Provisional Application Ser. No. 62/898,498, filed Sep. 10, 2019 under Attorney Docket No. L0769.70002US00, and entitled, “TECHNIQUES FOR SEMI-SUPERVISED TRAINING AND ASSOCIATED APPLICATIONS,” which is incorporated by reference herein in its entirety.

### BACKGROUND

The ability to repurpose safe drugs offers great advantages to the pharmaceutical industry, including time and cost savings, and increased rate of drug approval success.

### BRIEF SUMMARY

Some aspects of the technology described herein relate to a system comprising at least one encoder configured to map labeled input data to at least one space and adjust weights and/or biases of the encoder based on an energy metric relating to the map.

Some aspects of the technology described herein relate to a system comprising at least one trained encoder configured to map input data to at least one hyper-geometric space and at least one decoder configured to output an association of members of a data set of the input data based on the map.

Some aspects of the technology described herein relate to a system for predicting an association among input data, comprising at least one trained encoder configured to map the input data to at least one space and calculate an energy metric relating to the map, and at least one decoder configured to output a prediction, generated using the energy metric, associating members of a data pair of the input data.

Some aspects of the technology described herein relate to a method of identifying a biomarker comprising mapping, by at least one processor to at least one space, first biological data extracted from a patient, associating, by the at least one processor based on a grouping in the at least one space, the first biological data with second biological data related to patients having responded to a treatment, and predicting, by the at least one processor, that the patient will respond to the treatment.

Some aspects of the technology described herein relate to a method of predicting a combination therapy treatment comprising mapping, by at least one processor, compound and disease data to a common space, associating, by the at least one processor, a grouping of compound data and disease data in the common space, and associating, by the at least one processor, a sub-grouping of the compound data in a compound space.

Some aspects of the technology described herein relate to a method comprising comparing, by at least one processor, biological data within a domain, using multiple modalities of the biological data, to determine an association among the biological data.

Some aspects of the technology described herein relate to a method comprising comparing, by at least one processor, compound data with disease data, using multiple modalities of the compound data and the disease data, to determine a treatment association among the compound and disease data.

Some aspects of the technology described herein relate to a method, comprising conditioning, by at least one processor, input data to address noise present in the input data and predicting, by the at least one processor, a compound-disease association based on the input data.

Some aspects of the technology described herein relate to a method comprising predicting, by at least one processor, a compound-disease association based on a grouping of an encoded compound profile with an encoded disease profile in a common space.

Some aspects of the technology described herein relate to a method comprising identifying, by at least one processor, a relationship between a disease of a patient and a compound at least in part by matching disease data associated with the disease to compound data associated with the compound.

Some aspects of the technology described herein relate to a method comprising matching, by at least one processor, disease data with compound data to predict a treatment association.

Some aspects of the technology described herein relate to a method comprising comparing, by at least one processor, disease data with compound data to identify a treatment compound.

Some aspects of the technology described herein relate to a method of training an encoder, comprising mapping, by at least one processor, labeled input data to at least one space, calculating, by the at least one processor, an energy metric relating to the mapping, and adjusting, by the at least one processor, weights and/or biases of the encoder based on the energy metric.

Some aspects of the technology described herein relate to a method comprising mapping, by at least one processor, input data to at least one hyper-geometric space and determining, by the at least one processor, an association among the input data based on the mapping.

Some aspects of the technology described herein relate to a method of predicting an association among input data, comprising mapping, by at least one processor, the input data to at least one space, calculating, by the at least one processor, an energy metric based on a distance, in the at least one space, separating members of a data pair of the input data, and predicting, by the at least one processor based on the energy metric, that the members of the data pair are associated with one another.

It should be appreciated that all combinations of the foregoing concepts and additional concepts discussed in greater detail below (provided such concepts are not mutually inconsistent) are contemplated as being part of the inventive subject matter disclosed herein.

### BRIEF DESCRIPTION OF THE DRAWINGS

Various non-limiting embodiments of the technology will be described with reference to the following figures. It should be appreciated that the figures are not necessarily drawn to scale. In the drawings:

FIG. 1A is a diagram of an exemplary system configured to predict associations among input data, according to some embodiments.

FIG. 1B is a diagram of an exemplary system configured to predict associations among input data from multiple domains, according to some embodiments.

FIG. 1C is a diagram of the exemplary system of FIG. 1A, further configured to predict associations among multi-modal input data from multiple domains, according to some embodiments.

FIG. 2A is a flow diagram of an exemplary method for predicting an association among input data from one or more domains using an energy metric, according to some embodiments.

FIG. 2B is a flow diagram of an exemplary method for predicting an association among input data from multiple domains using an energy metric, according to some embodiments.

FIG. 3A is a diagram illustrating an exemplary common space including encoded input data from multiple domains, according to some embodiments.

FIG. 3B is a diagram illustrating an exemplary cluster of FIG. 3A, according to some embodiments.

FIG. 4A is a graph illustrating intra-domain correlation for exemplary input data prior to noise conditioning, according to some embodiments.

FIG. 4B is a graph illustrating inter-domain correlation for the exemplary input data of FIG. 4A prior to noise conditioning, according to some embodiments.

FIG. 4C is a graph illustrating intra-domain correlation for the exemplary input data of FIG. 4A after noise conditioning, according to some embodiments.

FIG. 4D is a graph illustrating inter-domain correlation for the exemplary input data of FIG. 4A after noise conditioning, according to some embodiments.

FIG. 5A is a flow diagram of an exemplary method for training an encoder to predict associations among input data using an energy metric, according to some embodiments.

FIG. 5B is a flow diagram of an exemplary method for training an encoder to predict associations among labeled input data using an energy metric, according to some embodiments.

FIG. 6A is a flow diagram of an exemplary method for training an encoder to predict associations among input data from multiple domains, according to some embodiments.

FIG. 6B is a flow diagram of an exemplary method for training an encoder to predict associations among labeled input data, according to some embodiments.

FIG. 7A is a graph illustrating energy decay of input data labeled as dissimilar, generated using an exponential energy metric, according to some embodiments.

FIG. 7B is a graph illustrating energy decay of input data labeled as similar, generated using an exponential energy metric, according to some embodiments.

FIG. 7C is a graph illustrating energy decay of input data labeled as dissimilar, generated using a logarithmic energy metric, according to some embodiments.

FIG. 7D is a graph illustrating energy decay of input data labeled as similar, generated using a logarithmic energy metric, according to some embodiments.

FIG. 7E is a graph illustrating energy decay of input data labeled as dissimilar, generated using a sigmoidal energy metric, according to some embodiments.

FIG. 7F is a graph illustrating energy decay of input data labeled as similar, generated using a sigmoidal energy metric, according to some embodiments.

FIG. 7G is a graph illustrating energy decay of input data labeled as dissimilar, generated using a rectified energy metric, according to some embodiments.

FIG. 7H is a graph illustrating energy decay of input data labeled as similar, generated using a rectified energy metric, according to some embodiments.

FIG. 8 is a diagram of an exemplary computer system, according to some embodiments.

### DETAILED DESCRIPTION

Aspects of the present disclosure provide semi-supervised machine learning techniques and associated computer-implemented applications. Some aspects provide a system configured to identify associations among data input to the system. In some embodiments, the system may map the input data to one or more vector spaces, such that associated groups of the input data form associated clusters in the vector space(s). For example, the mapping may be performed by one or more trained encoders (e.g., neural network encoders) of the system. Accordingly, a distance separating two data entries in a space may indicate a likelihood of association among the data entries. Various applications of such systems are described herein, such as identifying a treatment relationship among biological data (e.g., relating to drug compounds and diseases), identifying an association among financial market conditions and market events (e.g., crashes), and determining a relationship between vehicle traffic conditions and traffic accidents.

Some system components described herein may be trained using semi-supervised machine learning techniques, combining aspects of unsupervised and supervised machine learning. Typically, supervised machine learning includes providing labeled training data to a classifier and penalizing or rewarding the classifier depending on whether the classifier correctly classifies the training data. For example, training a classifier to classify images of objects labeled as red, blue, or green may include rewarding the classifier for correctly classifying a green-labeled image of grass as green, and penalizing the classifier for incorrectly classifying a red-labeled image of a firetruck as blue. Thus, the classifier may properly classify future image inputs and infer whether to classify the images as red, blue or green. The inventors recognized that supervised learning techniques are useful for sorting new data into known categories, as in the image example.

In contrast, unsupervised machine learning typically includes providing unlabeled training data to an encoder which the encoder may sort into self-similar groups. For example, the same images provided to the classifier above may be provided to an encoder, which may map the images into a continuous space. In this example, the encoder may form clusters of similar images based on various perceived characteristics of the images, such as the color of the object in each image. However, unlike training the classifier, the encoder may take into account other characteristics of the input data, such as the shape of the objects in the images, and the encoder is not penalized for doing so in the manner described for the classifier. Accordingly, such encoders may be configured to group future inputs based on characteristics encountered during training.

The inventors recognized that unsupervised learning techniques are useful for sorting new data into categories that were not defined prior to training, such as for generating biological or financial predictions, the basis for which may be unknown at times. However, the inventors also recognized that subtle yet important differences in input data may be overlooked when noise is present in the data. For example, in a biological example, biological characteristics that have a low impact in determining a treatment association (e.g., between a compound and a disease, between two compounds, etc.) may drown out biological data characteristics that have a higher impact. In some cases, two compounds or two diseases may have a high-impact gene expression characteristic difference that may be treated as insignificant because the two compounds or diseases share other low-impact characteristics, such as a complementary compound chemical structure or common disease symptoms. This phenomenon may cause an encoder to associate data despite high-impact differences, resulting in a false indication of association among the data. In the biological example, this result may cause treatment association predictions to be unreliable. It should be appreciated that similar issues can arise in other applications beyond the biological example, as described further herein.

To address these problems, the inventors developed semi-supervised machine learning techniques which augment the self-similar group forming aspects of unsupervised machine learning with supervised data labels that may facilitate emphasizing and/or de-emphasizing particular data characteristics. The inventors recognized that, by labeling input data entries (e.g., as similar or different), an encoder may be trained to emphasize characteristics in the data. In the above biological example, subtle, yet high-impact differences among two compounds may be emphasized by labeling the compounds as dissimilar and penalizing the encoder for associating the compounds as though they were similar. Accordingly, the encoder may learn to recognize the subtle differences in future inputs. Moreover, the encoders may be trained to form accurate predictions on new (e.g., newly available) data, facilitating scalability and the capacity for continuous improvement.

In some embodiments, semi-supervised machine learning techniques described herein may employ loss functions that incorporate an energy metric, which may determine the impact of data labels during training. The inventors recognized that the energy metric may provide a continuous feedback measurement to the encoder, rather than a discrete indication of whether or not the encoder is correct. For example, an exponential energy metric, which increases or decreases exponentially with distance separating a known data pair, may provide a weighted indication of how correct or incorrect the mapping is, rather than a discrete indication of whether the mapping is correct or incorrect. It should be appreciated that some embodiments employ more or less discretized versions of the energy metric, such as an energy metric which indicates correctness using a number of discrete degrees (e.g., mapping is off by 2 degrees, etc.) rather than a fully continuous metric. In some embodiments, the energy metric may provide a likelihood of predicted associations. For example, the energy metric may indicate the barrier (e.g., the size of the loss function that would be incurred during training) the data overcame to be positioned within a given proximity in the space.

Some embodiments further provide multi-modal data encoding within a domain. For example, a system may include multiple encoders corresponding to multiple modalities. For example, in a biological application, a system may include a compound gene expression encoder and a compound chemical structure encoder within the compound domain, and/or a disease symptom encoder and a disease biological pathway encoder within the disease domain. Accordingly, encoded data produced by the multi-modal encoders may be combined when predicting intra-domain associations (e.g., compound-compound, disease-disease) and/or inter-domain associations (e.g., compound-disease). The inventors recognized that incorporating data from different modalities within a domain provides more holistic prediction associations.

In one example application, a system described herein may be configured to identify a treatment relationship among biological data input to the system (e.g., relating to drug compounds and diseases). For example, one or more trained encoders of the system may be configured to group drug compounds sharing common biological characteristics (e.g., gene expression characteristics, etc.) in a compound space, and/or to group compounds and diseases sharing complementary biological characteristics together in a common space.

Computational algorithms aiming to predict new disease indications for existing drugs or new treatments for existing diseases have recently emerged with the improvements in computer infrastructure and the advent of high throughput technologies enabling the characterization of diseases and drugs at a high resolution. Some aspects of the present disclosure provide computer-implemented techniques which may be useful in determining new treatment associations among known drugs and diseases. For example, some embodiments match known drugs (e.g., known to be safe and/or effective at treating at least one disease) with known diseases to determine new treatment associations. Some embodiments further provide predictions for how effective the treatment association may be. Alternatively or additionally, some embodiments compare known drugs to a particular disease to identify at least one treatment compound for the disease. Among other applications, techniques described herein may be used to repurpose drugs, reducing the time it takes for effective treatments to reach patients suffering from associated diseases. Such techniques may be useful in applications other than determining biological relationships, as described further herein.

Some aspects of the technology described herein provide for real-time analysis of input data and subsequent (and/or simultaneous) generation of association predictions. In some applications, healthcare professionals such as doctors and/or researchers may input biological data to a system described further herein, and obtain treatment association predictions from the system based on the inputs. The biological data may be from multiple domains, such as compounds and diseases. Some of the biological data may be related to a disease of a patient and/or a compound the patient has been prescribed. For example, the biological data input to the system may include gene expression data extracted from a patient. Other portions of the biological data, such as for comparing to or matching with the patient biological data, may be stored on and/or accessed by the system (e.g., over a communication network). The biological data may alternatively or additionally include data from multiple modalities, such as compound chemical structure, disease symptom(s), and the like. As described herein, compound gene expression data may be publicly available data from the Broad Institute Connectivity Map (clue.io/cmap), and disease gene expression data may be publicly available from the Gene Expression Omnibus (www.ncbi.nlm.nih.gov/geo).

In any case, the system may compare and/or match biological data from multiple domains to predict a treatment association. For example, given an input disease (e.g., using data extracted from the patient), the system may identify a compound (e.g., using data accessed over the communication network) that is predicted to be effective in treating the disease. Alternatively or additionally, given an input compound, the system may identify a disease that the compound is predicted to effectively treat. In some embodiments, the system may output the treatment association results along with an indication of how likely the predicted association is estimated to be effective. For example, the system may assign a degree of confidence to each prediction based on internal system metrics described further herein. It should be appreciated that further applications of real-time analysis and prediction (e.g., financial predictions) are possible, as described further herein.

The following figures illustrate systems and methods for various applications of the technology described herein. It should be appreciated that the illustrated systems and methods may be adapted for other applications than just those specified, as described further herein.

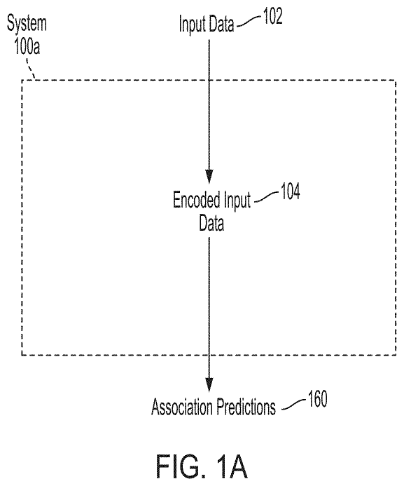

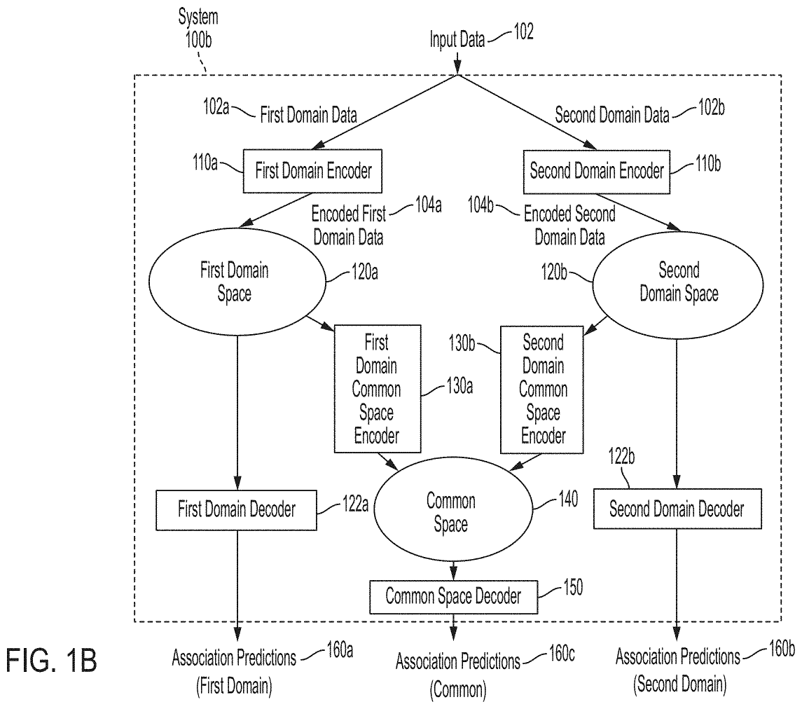

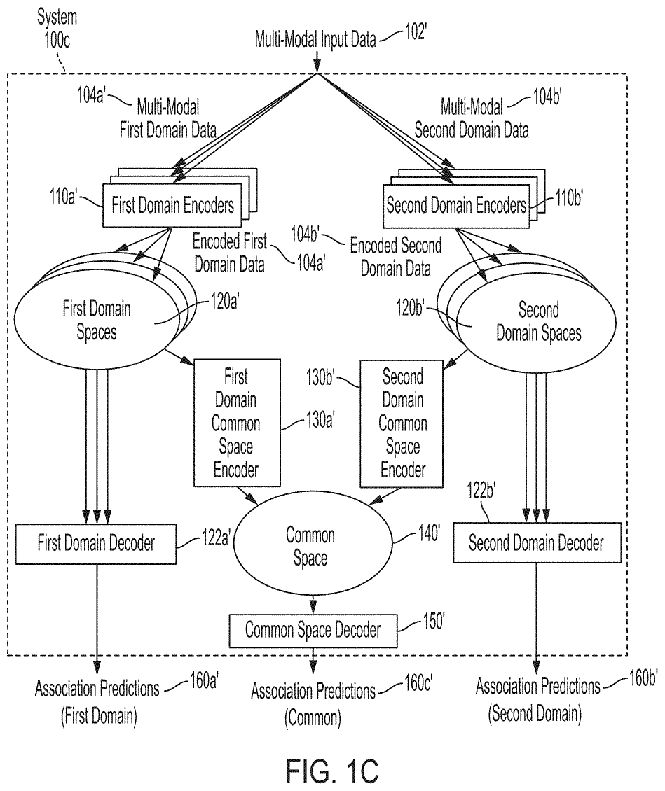

FIG. 1A is a diagram of exemplary system 100a configured to predict associations among input data 102, according to some embodiments. System 100a may receive input data 102 and encode input data 102 to generate encoded input data 104, which may serve as the basis for forming association predictions 160.

Input data 102 may include data from multiple domains, such as compound data and disease data. Alternatively or additionally, input data 102 may include data from multiple modalities within a domain, as described further herein including with reference to FIG. 1C. Some portions of input data 102 may be provided to system 100a via a user interface, such as entered using a human interface device (e.g., mouse and keyboard, touchscreen, microphone, etc.). Other portions of input data 102 may be sourced from publicly and/or privately (e.g., internally) sourced data, such as over a communication network. In a biological example, input data 102 may be sourced from one or multiple publicly accessible biological databases, such as gene expression databases available on the Internet. In this example, some portions of input data 102 may be related to a patient. For example, such portions of input data 102 may be extracted from a patient, and may be indicative of a disease with which the patient has been diagnosed.

System 100a may encode input data 102 to generate encoded input data 104, such as by mapping input data 102 to one or more vector representation spaces. For example, input data 102 may have multiple features that may be mapped to columns in the vector space. In some embodiments, input data 102 may include data for multiple domains (e.g., compound and disease), and system 100a may map data from each domain to a domain-specific representation space. For example, compound data may be encoded to a compound space. Then, encoded input data 104 from multiple domains may be combined into a common space prior to forming at least some of association predictions 160. In a biological example, system 100a may map compound and disease data to a common space for comparison and/or matching, such as to generate one or more treatment associations. Alternatively or additionally, some of association predictions 160 may be formed using data from the domain-specific spaces, such as associations among data within a domain. In the biological example, associations among compounds may be generated by comparing and/or matching compound data in a compound-specific space. Some embodiments may generate association predictions 160 using a combination of domain-specific and inter-domain comparisons and/or matching.

In some embodiments, association predictions 160 may use distances separating encoded input data 104 within one or more spaces. As an example, closer spacing among data entries in the space may be the result of similarity and/or compatibility, thus indicating a higher likelihood of association, and farther spacing may be the result of dissimilarity and/or incompatibility, thus indicating a lower likelihood of association. For instance, a domain-specific (e.g., compound) association prediction may use distances separating encoded input data 104 within the domain-specific (e.g., compound) space, indicating similarity or dissimilarity. An inter-domain (e.g., compound-disease) association prediction may use distances separating encoded input data 104 within the common space, indicating compatibility or incompatibility. In some cases, association predictions 160 may incorporate distances separating encoded input data 104 within a domain-specific spaces and distances in a common space.

Other applications of system 100a may include identifying financial market conditions and predicting market outcomes (e.g., crashes), and identifying traffic conditions to predict traffic accidents. For example, in such applications, financial or traffic data may be provided to system 100a for encoding and prediction of associations in the manner described for biological data. For example, rather than predicting treatment associations among compounds and diseases, system 100a may be adapted to predict financial crashes or car accidents given the corresponding input data.

FIG. 1B is a diagram of exemplary system 100b configured to predict associations among input data 102 from multiple domains, according to some embodiments. System 100b may be configured in the manner described for system 100a, and may be further configured to predict associations based on input data 102a from a first domain and input data 102b from a second domain. In the biological example, input data 102a may include compound data, and input data 102b may include disease data. Association predictions 160a may be generated using input data 102a, association predictions 160b may be generated using input data 102b, and association predictions 160c may be generated using a combination of input data 102a and 102b. In some embodiments, association predictions 160c may further incorporate association predictions 160a and/or 160b.

System 100b includes first domain encoder 110a, first domain space 120a, and first domain decoder 122a configured to output prediction associations 160a from first domain space 120a using first domain input data 102a. Likewise, system 100b includes second domain encoder 110b, second domain space 120b, and second domain decoder 122b configured to output prediction associations 160b generated in second domain space 120a using second domain input data 102b. Additionally, system 100b includes first and second domain common space encoders 130a and 130b, common space 140, and common space decoder 150 configured to output prediction associations 160c generated in common space 140 using input data 102 from both domains.

First and second domain encoders 110a and 110b may be trained encoders configured to respectively transform input data 102a and 102b into vector representations for mapping to first domain space 120a and second domain space 120b. For example, in some embodiments, first domain encoder 110a may non-linearly encode characteristics of first domain input data 102a into vector representations (i.e., encoded first domain data 104a) having lower dimensionality than first domain input data 102a. In some embodiments, first and second domain encoders 110a and 110b may be configured to position vector representations of input data 102a and 102b in first and second domain spaces 120a and 120b based on respective characteristics of encoded first and second domain data 104a and 104b. For example, various characteristics of encoded first domain data 104a may have numerical values entered as components of the vector representations and corresponding to features indicated in input data 102a. Accordingly, in some embodiments, the vector representations may be positioned according to such components. In some embodiments, first and second domain spaces 120a and 120b may include hyper-geometric spaces, such as surfaces of respective hyperspheres, so that the vector components may be plotted on the surfaces. Other hyper-geometric spaces may be used, such as a polytope, hypercube, and/or the like.

In some embodiments, first domain encoder 110a may be a neural network encoder with a plurality of feed-forward layers. An exemplary embodiment of first domain encoder 110a configured to encode compound gene expression data includes six layers of sizes 971, 800, 400, 200, 100, and 30. An exemplary embodiment of second domain encoder 110b configured to encode disease gene expression data includes six layers of sizes 1803, 2000, 800, 300, 100, and 30. It should be appreciated that embodiments of first domain encoder 110a and second domain encoder 110b configured to encode data from other modalities or domains may use different layer sizes.

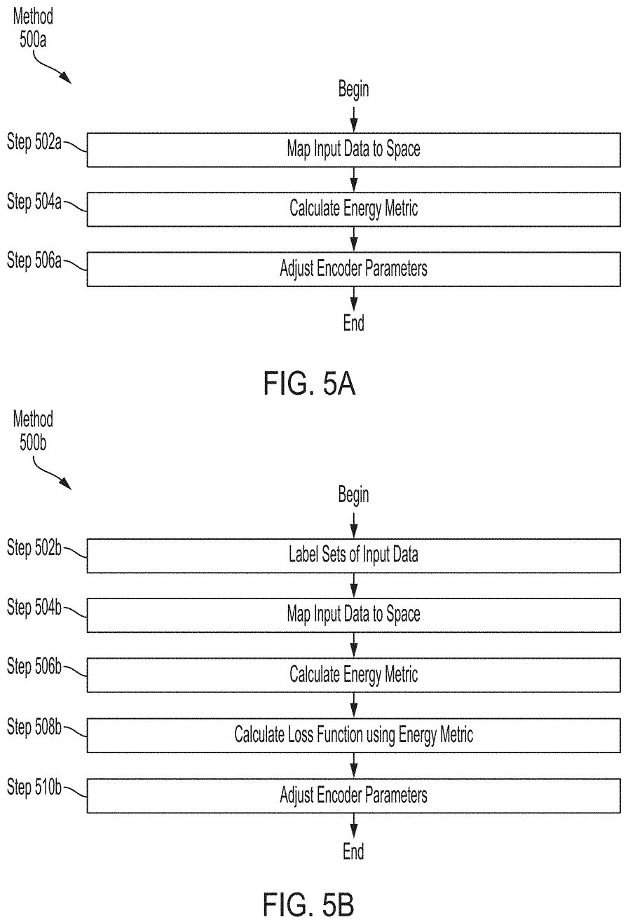

In some embodiments, first and second domain encoders 110a and 110b may be trained to apply weighted transforms to first and second domain data 104a and 104b. For example, the weighted transform of first domain encoder 110a may prepare first domain input data 102a for comparison and/or matching with second domain data 104b in common space 140. In some instances, first domain encoder 110a may be trained using one or more techniques described further herein (e.g., in connection with FIGS. 5A-5B) such that the weighted transform weighs some first domain characteristics more than others in determining positioning of first domain data 104a in first domain space 120a. In a biological example, the weighted transform may emphasize a particular compound characteristic and/or de-emphasize a compound characteristic such that not all compound characteristics are weighed equally in encoding the vector representations to determine positioning of encoded compound data in the compound space. It should be appreciated that first and second domain encoders 110a and 110b may be structured differently and/or may weigh characteristics differently according to the different data domains and/or modalities for which each encoder is configured.

Such training may include providing training data to first and second domain encoders 110a and 110b. For example, first domain encoder 110a and/or second domain encoder 110b may be provided with training data (e.g., particular to the domain and/or modality of the encoder), portions of which may be labeled as similar to and/or dissimilar from other portions, such that the encoder may be penalized for mapping similar training data far apart and/or different training data close together. In some embodiments, an energy metric may be incorporated during training. For example, a loss function used to penalize the encoder based on distances separating a labeled pair may incorporate the energy metric. In some instances, the energy metric may be a continuous function which increases and/or decreases based on the distance. The impact of the energy function may depend on the label assigned to the training data, such as having an increasing impact for data spaced increasingly farther and labeled as similar. By training first and second domain encoders 110a and 110b to group labeled data, the encoders may be configured to recognize patterns of input data when grouping new input data not encountered during training. In some embodiments, the training data may overlap with first domain data 104a (or second domain data 104b for second domain encoder 110b) provided during use of system 100a, such that first domain data 104a is encoded in the same manner during use as during training. In the biological example, first domain data 104a provided during use of system 100a may include compound data used to train the encoder and may further include data for a compound having no known treatment relationship. As a result, the compound encoder was not trained to encode the data for the compound, and instead the encoder may encode the data using inferences (e.g., based on patterns perceived during training). In the biological example, the encoder may group the encoded compound data with other encoded compound groupings based on inferred similarity of compound characteristics. Accordingly, when combined in common space 140, the compound may indicate a similar likelihood of association to various diseases as the similar compounds in the group.

Data mappings from first and second domain encoders 110a and 110b may generate domain-specific (e.g., compound-compound, disease-disease, etc.) association predictions 160a and 160b in first and second domain spaces 120a and 120b. For instance, association predictions 160a and 160b may be based on the respective mappings of encoded first and second domain data 104a and 104b to first domain space 120a and second domain space 120b. In a biological example, the first domain may be compounds, and a distance separating a representation of a first compound from a representation of a second compound in first domain space 120a may indicate an association (or a lack thereof) among the first and second compounds. In this example, the second domain may be diseases, and a distance separating representations of first and second diseases in second domain space 120b may indicate an association (or lack thereof) among the first and second diseases. In some embodiments, an energy metric (e.g., used to train first or second domain encoder 110a or 110b) may be used to determine a likelihood for some or each of association predictions 160a or 160b. For instance, the energy metric may contextualize the distance separating the data entries in the space, such as by comparing the distance to distances separating other data entries in the space. In some instances, the energy metric may have been used during training of first or second domain encoder 110a or 110b, and may indicate the extent to which the encoder would be penalized if the distance were incorrect. In embodiments in which first and/or second domain space 120a or 120b includes a hyper-geometric space, a parameter (e.g., hyper-parameter) of the space may be incorporated into the energy metric, facilitating consideration of the hyper-geometric shape during determination of the likelihood. In the biological example, a compound-compound pair may be labeled as similar during training such that first domain encoder 110a is penalized for positioning the pair far apart. An energy metric in this case may have a term (e.g., an exponential term) that increases as the distance separating the pair increases. The energy metric may be included a loss function used to penalize and/or reward the encoder based on the mapping. When generating associations 160a, a corresponding energy metric may be calculated assuming a predicted association is correct and/or incorrect to determine how large the impact of the energy metric may be on the loss function. First and second domain decoders 122a and 122b may be configured to output association predictions 160a and 160b from first and second domain spaces 120a and 120b.

In some embodiments, first and second domain decoders 122a and 122b may only output association predictions 160a or 160b for particular portions of encoded first or second domain data 104a or 104b (e.g., particular compounds and/or diseases) and not for all of encoded first and second domain data 104a and 104b. For example, some portions may have no known association, and first or second domain decoder 110a or 110b may be configured to output association predictions 160a or 160b indicating the likelihood of such a relationship. In some embodiments, first and second domain decoders 110a and 110b may be configured to output association predictions 160a and 160b for pairings of first or second domain data 104a or 104b (e.g., compounds or diseases) that do not overlap with data used to train the decoders. An exemplary embodiment of first domain decoder 122a configured for compound gene expression data may include six layers having sizes 971, 800, 400, 200, 100, and 30. An exemplary embodiment of second domain decoder 122b configured for disease gene expression data may include six layers having sizes 30, 100, 300, 800, 2000, and 1803. It should be appreciated that first and second domain decoders 122a and 122b may be structured differently and/or may weigh characteristics differently according to the different data domains and/or modalities for which each decoder is configured.

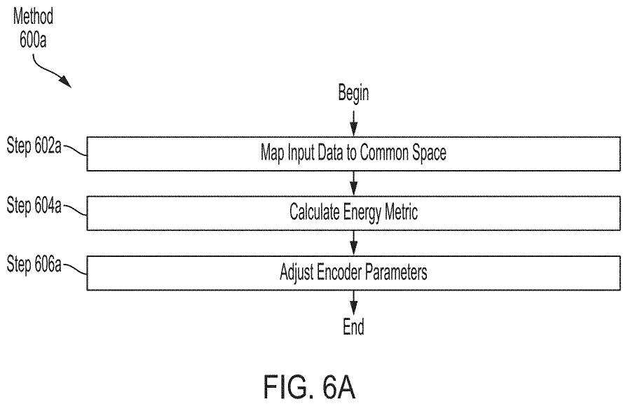

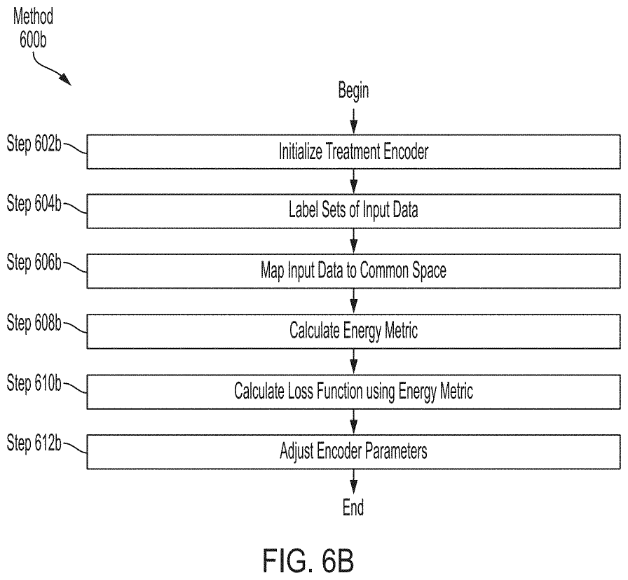

Common space encoders 130a and 130b may be configured to further transform encoded first and second domain data 104a and 104b for mapping to common space 140 (e.g., a surface of a hypersphere, etc.). In some embodiments, common space encoders 130a and 130b may be configured to generate vector representations based on the likelihood of association of portions of encoded first domain data 104a (e.g., compound representations) with portions of encoded second domain data 104b (e.g., disease representations). In some embodiments, common space encoders 130a and 130b may be trained (e.g., per FIGS. 6A-6C), using training data from respective domains, to group portions of encoded first domain data 104a with portions of encoded second domain data 104b according to the likelihood of association among the portions. In a biological example, first domain common space encoder 130a may be trained to map first domain biological data (e.g., compounds) having particular biological characteristics (e.g., gene expression characteristics) to a particular portion of the space. In this example, second domain common space encoder 130b may be trained to map second domain biological data (e.g., diseases) having corresponding biological characteristics to the same portion of the space. In some cases, such training may include labeling known associated pairs and pairs with no known relationship, such that common space encoders 130a and 130b may be penalized (e.g., independently and/or collectively) for separating known associated pairs and grouping pairs having no known relationship. As for first and second domain encoders 110a and 110b, common space encoders 130a and 130b may be trained using an energy metric. Because common space encoders 130a and 130b may be trained to form pairs by taking into account the common and/or differing characteristics which lead to particular mappings, common space encoders 130a and 130b may later recognize various characteristics (e.g., independently of the other) when mapping new data not encountered during training. In some embodiments, the training data may overlap with first and/or second domain data 104a and/or 104b provided during use of system 100b. For example, additional data may be included in first and/or second domain data 104a and/or 104b beyond the training set for determining whether an association may be predicted using the additional data. An exemplary embodiment of first domain common space encoder 130a configured to map compound gene expression data to common space 140 may have six layers of sizes 100, 70, 30, 10, and 3. An exemplary embodiment of second domain common space encoder 130b configured to map disease gene expression data to common space 140 may have six layers identically sized to 5 for mapping disease gene expression data to common space 140. It should be appreciated that common space encoders 130a and 130b may be structured differently and/or may weigh characteristics differently according to the data domains and/or modalities for which the encoder is configured.

It should be appreciated that, in some embodiments, system 100b may include one common space encoder for some or all domains. For example, a single common space encoder may be configured to transform encoded compound and disease data into common space 140, with separate encoding layers configured for compound encoding and disease encoding.

Data mappings of first and second domain data 104a and 104b may generate inter-domain (e.g., compound-disease) associations in common space 140. In a biological example, a distance separating a first domain representation of a compound from a second domain representation of a disease in common space 140 may indicate a treatment association (or a lack thereof) among the compound and the disease. In some embodiments, an energy metric (e.g., used to train common space encoders 130a and/or 130b) may determine a likelihood for some or each of association predictions 160c. For example, an energy metric may be used to contextualize the distance separating the data entries in the space, such as by comparing the distance to distances separating other data entries in the space. In some instances, the energy metric may have been used during training of common space encoder 130a and/or 130b, and may indicate the extent to which common space encoder 130a and/or 130b would be penalized if the distance were incorrect. In embodiments in which common space 140 is a hyper-geometric surface, a parameter (e.g., hyper-parameter) of the space may be incorporated into the energy metric, which facilitates consideration of the shape of the space when determining the likelihood of the association. In the biological example, a compound-disease pair may be labeled as effective during training such that common space encoder 130a and/or 130b is/are penalized for positioning the pair far apart. An energy metric in such a case may have a term (e.g., an exponential term) that increases as the distance separating the pair increases. The energy metric may be included in a loss function used to penalize and/or reward the encoder based on the mapping. Likewise, when generating association predictions 160c, an energy metric may be calculated which calculates the energy metric assuming a predicted association is correct and/or incorrect to determine how large the impact of the energy metric may be on the loss function.

In some embodiments, common space decoder 150 may only output association predictions 160c for particular pairings of input data and not for all of first and/or second domain data 104a and/or 104b. In the biological example, some compounds and/or diseases may have no known treatment relationship, and common space decoder 150 may be configured to output association predictions 160c indicating the likelihood of such relationships. In some embodiments, common space decoder 150 may be configured to output association predictions 160c for pairings of first and second domain data 104a and 104b that were not included in training data used to train common space encoders 130a and/or 130b.

The inventors have recognized that encoding first and second domain data 104a and 104b from different domains using separate domain-specific encoders 110a and 110b prior to encoding the input data to common space 140 may improve accuracy of association predictions 160c. For example, by encoding first and second domain data 104a and 104b directly into common space 140, first and second domain data 104a and 104b may be encoded based on a combination of intra-domain similarity and also on the inter-domain likelihood of association. The inventors determined that having at least one domain-specific encoder and space for each data domain may remove at least some domain-specific encoding responsibility from common space encoders 130a and 130b, such that common space encoders 130a and 130b may focus on inter-domain association. In a biological example, first domain encoder 110a may be trained to emphasize or de-emphasize a particular compound characteristic (e.g., increase/decrease the impact of the characteristic on the mapping) that indicates a strong similarity or difference between compounds. Accordingly, in this example, common space encoders 130a and 130b may not need to be trained to address that particular characteristic, allowing training of common space encoders 130a and 130b to be more focused on inter-domain specific interactions. Moreover, by encoding first domain data 104a into first domain space 120a, positioning of vector representations of first domain data 104a may be weighed according to characteristics specific to the first domain in a manner that is also specific to the first domain (e.g., specific to compounds rather than diseases). The same considerations may apply to second domain data 104b, in accordance with various embodiments. In any case, by focusing training of common space encoders 130a and 130b on fewer parameters more specific to inter-domain interaction (e.g., compound-disease interaction), techniques described herein result in higher quality encoder training and more accurate association predictions 160c.

It should be appreciated that, although only two domains are illustrated in FIG. 1B, system 100b may be adapted to accommodate more than two domains. For example, a traffic application of system 100b may include a first domain encoder for traffic conditions (e.g., number of cars), a second domain encoder for weather conditions (e.g., rain), and a third domain encoder for traffic accidents (e.g., multi-car collisions) to facilitate associations across the various data domains.

As described herein, system 100b may be adapted for applications other than biological data. For example, in traffic or financial market applications. In one example, the first and second domains may be traffic conditions and traffic accidents, where first domain encoder 110a may be configured to associate traffic conditions with one another, second domain encoder 110b may be configured to associate traffic accidents with one another, and common space encoders 130a and 130b may be configured to associate traffic conditions with traffic accidents. In another example, the first and second domains may be market conditions and market events, where first domain encoder 110a may be configured to associate market conditions with one another, second domain encoder 110b may be configured to associate market events with one another, and common space encoders 130a and 130b may be configured to associate market conditions with market events.

FIG. 1C is a diagram of exemplary system 100c configured to predict associations among input data 102′ from multiple domains using multiple modalities, according to some embodiments. In addition to being configured in the manner described for system 100b, system 100c may be further configured to predict associations based on multi-modal first domain input data 102a′ and multi-modal second domain input data 102b′. In a biological example, the first domain may be compounds and multi-modal input data 102a′ may include compound gene expression data, compound chemical structure data, compound target data, compound side effect data, and/or the like. In this example, the second domain may be diseases and multi-modal input data 102b′ may include disease gene expression data, disease symptom data, disease biological pathway data, disease proteomic data, or other such modalities. As described for system 100b, association predictions 160a′ may be formed using input data 102a′, association predictions 160b′ may be formed using input data 102b′, and association predictions 160c′ may be formed using a combination of input data 102a′ and 102b.′

In contrast to system 100b, system 100c includes multiple first domain encoders 110a′ configured to encode the various modalities (e.g., gene expression, chemical structure, etc.) of the first domain, and multiple second domain encoders 110b′ configured to encode the various modalities of the second domain (e.g., gene expression, pathway, etc.), each of which may be configured in the manner described for first domain encoder 110a and second domain encoder 110b, and may be further adapted for a particular modality. For example, each encoder may be trained using data specific to its modality, resulting in each encoder potentially employing a different weighted transform. Corresponding to the multiple encoders, system 100c further includes multiple first domain spaces 120a′ and second domain spaces 120b′, each of which may be configured in the manner described for first domain space 120a and second domain space 120b, and may be adapted for the particular modality.

It should be appreciated that, in some embodiments, multi-modal input data within a domain may be combined prior to encoding into common space 140′ by common space encoders 130a′ and 130b′. In the biological example, encoded compound gene expression data and encoded compound chemical structure data may be combined (e.g., by vector concatenation) into an aggregation of compound data prior to common encoding. In this example, multi-modal disease data may be likewise combined. In some embodiments, the different domains may include different numbers of data modalities. Further, although three modalities are illustrated for each domain in FIG. 1C, it should be appreciated that any number of modalities may be accommodated by embodiments of system 100c.

As described for systems 100a and 100b, other applications of system 100c are possible. In the traffic example, traffic condition and/or accident data may be gathered from multiple modalities (e.g., sources, types, etc.) of data. Accordingly, multiple first and second domain encoders 110a′ and 110b′ may be provided to accommodate the different modalities, as may be the case for other components of system 100c.

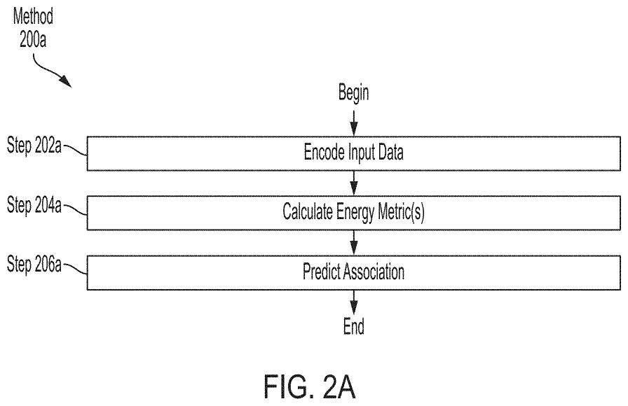

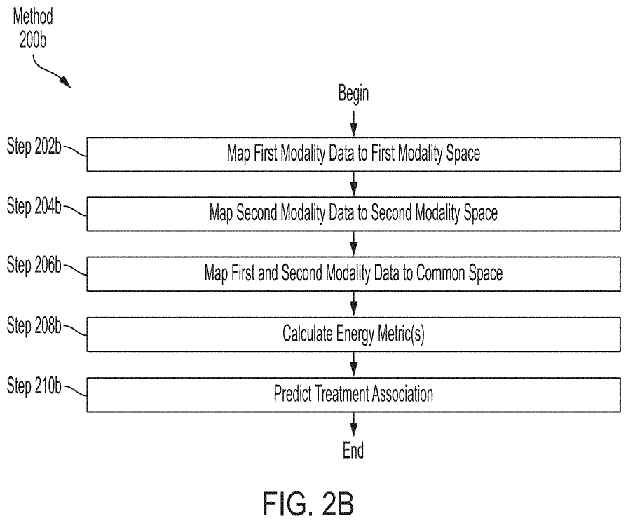

FIG. 2A is a flow diagram of exemplary method 200a for predicting an association among input data from one or more domains using an energy metric, according to some embodiments.

Methods described herein may be performed by components of any system described herein. For example, in some embodiments, method 200a may be performed by components of systems 100a, 100b, and/or 100c. Method 200a includes encoding input data 102 to generate encoded input data 104 at step 202a, calculating an energy metric using encoded input data 104 at step 204a, and predicting one or more associations 160 among encoded input data 104 at step 206a. It should be appreciated that the association prediction(s) may pertain to associations among data within a domain (e.g., compounds), within a modality of a domain (e.g., compound gene expression), and/or among multiple domains (e.g., compound-disease pairings).

Encoding input data 102 to generate encoded input data 104 at step 202a may include mapping input data 102 from one or more domains to a domain-specific or inter-domain vector space using one or more encoders, depending on whether the associations to be predicted are within a domain, within a modality, and/or among domains. For example, for associations within a domain, step 202a may include first domain encoder 110a encoding first domain data (e.g., uni-modal, multi-modal) into a first domain space. Alternatively or additionally, for associations within a modality, multiple first domain encoders 110a′ may map multiple modalities of first domain data 102a′ (e.g., compound gene expression data and compound chemical structure data) to respective first domain spaces 120a′, such that associations for one or each modality may be formed from the corresponding space(s). For inter-domain associations, step 202a may include likewise steps for encoding data from a second domain (e.g., uni-modal, multi-modal) using one or more second domain-specific encoders and spaces. Step 202a may also include encoding the first and second domain data to common space 140, such as using common space encoders 130a and 130b, such that associations may be formed from common space 140.

Calculating the energy metric(s) at step 204a may include incorporating a distance separating at least some of encoded input data 104, such as a data set (e.g., pair) from a first domain for associations within the first domain, a first modality from the first domain for associations within a modality, and/or data from multiple domains for inter-domain associations. For example, the distance separating the data pairs may indicate a likelihood of association to be incorporated in predicting associations at step 206a. In some embodiments, the energy metric may be similar or identical to an energy metric used in training one or more first domain encoders 110a or 110a′, second domain encoder(s) 110b or 110b′, and/or common space encoders 130a, 130b, 130a′, or 130b′.

Predicting the association(s) at step 206a may include grouping portions of encoded input data 104. For example, as indicated above, groupings may include portions of data within a first domain, within a modality of the first domain, and/or among multiple domains. Predicting the association(s) at step 206a may also include determining that the energy metric(s) calculated at step 204a indicates a high accuracy for the predicted association(s). For example, the energy metric(s) may indicate that the distance separating a data pair would have a very low impact on the loss function if the pair were assumed to be an effective treatment pair. Accordingly, the likelihood of error may be determined to be low.

It should be appreciated that method 200a may be adapted for other applications. For example, in one application, trained encoders may map movie data and consumer preference data to one or more spaces and predict associations among the movie data and/or among the consumer preference data and the movie data to determine which types of consumers may be likely to see a new movie in theaters. Other applications described herein are possible as well.

FIG. 2B is a flow diagram of exemplary method 200b for predicting an association among input data from multiple domains using an energy metric, according to some embodiments. Method 200b includes mapping first domain input data 102a to first domain space 120a at step 202b and mapping second domain input data 102b to second domain space 120b at step 204b. Method 200b further includes mapping encoded first and second domain data 104a and 104b to common space 140 at step 206b, calculating one or more energy metrics at step 208b, and predicting one or more association predictions at step 210b, which may be performed in the manner described for steps 202a, 204a, and 206a of method 200a, respectively. It should be appreciated that aspects of method 200b described with reference to portions of system 100b may be performed using corresponding portions of system 100c as well.

Mapping first domain data 104a to first domain space 120a at step 202b may include generating vector representations of first domain input data 102a based on characteristics of first domain input data 102a. In some embodiments, generating the vector representations may include reducing a dimensionality of first domain input data 102a. In some embodiments, first domain space 120a may be a hyper-geometric space, and mapping first domain input data 102a to first domain space 120a may include incorporating a hyper-parameter of the space. Mapping second domain input data 102b to second domain space 120b at step 202c may be performed in the manner described for step 202b, with additional considerations for addressing second domain data rather than first domain data. In some embodiments, mapping first domain input data 102a and/or second domain input data 102b to respective spaces may include applying at least one weighted transform having the form described further herein including with reference to FIG. 5A.

In some applications, method 200b may be used to identify biomarkers within one or more patients, and/or to identify a treatment compound for the patient. For instance, association predictions 160c may indicate whether biological data taken (e.g., extracted) from a patient and input to system 100a, 100b, or 100c associates with biological data for a particular treatment (e.g., compound), and/or disease data from patients known to have responded or not responded to the same or other treatments. In some embodiments, the distance separating the biological data from the patient data may indicate a likelihood of association. In the above example, the association may indicate how likely the patient is to respond to the treatment.

In some applications, method 200b may be used to predict combination therapies (e.g., including a combination of compounds). For example, the inventors recognized that effective drug combination therapies may include a combination of compounds that are likely to treat a particular disease and which utilize different (e.g., orthogonal) treatment mechanisms. Accordingly, in the drug combination theory example, association predictions 160c may indicate whether one or more compounds are likely to treat a disease, and association predictions 160a, for example, may indicate which compounds utilize orthogonal mechanisms, such as if the compounds are spaced far from one another within first domain space 120a. As a result, some embodiments may predict drug combination therapies by a group of compounds positioned in close proximity to a particular disease in common space 140 and then selecting a sub-group from the group that are positioned far from one another in first domain space 120a.

Method 200b may be adapted for other applications, such as traffic accident, financial market, and other such predictions. For example, one encoder may map traffic condition data to a first space and another encoder may map traffic accident data a second space prior to combining the data in a common space. In another example, one encoder may map movie data to a first space and another encoder may map consumer preference data to a second space prior to combining the data in a common space.

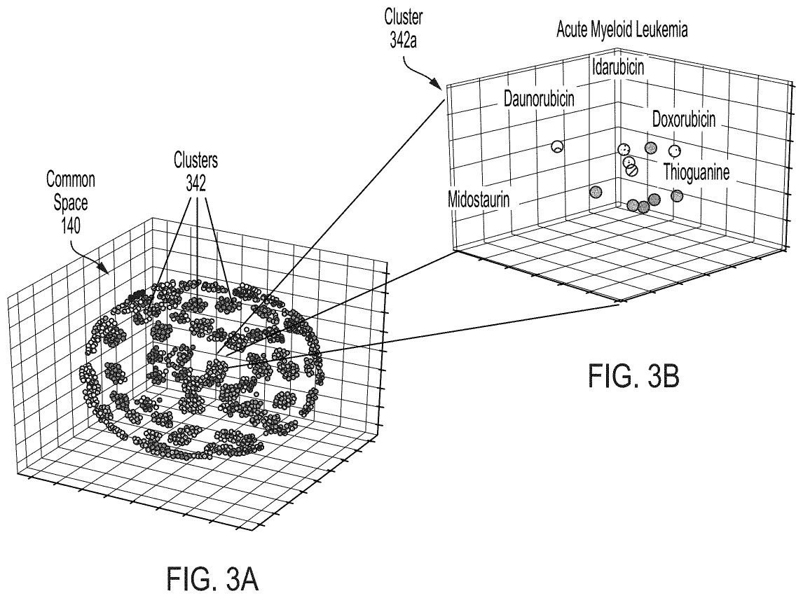

FIGS. 3A and 3B show a diagram illustrating exemplary common space 140 including clusters 342 of encoded first and domain data 104a and 104b, according to some embodiments. As shown, clusters 342 include first and domain data 104a and 104b encoded according to biological characteristics. In this example, each cluster 342 represents a grouping of compound gene expression data and disease gene expression data 104b with similar and/or associated gene expression characteristics.

Turning to cluster 342a, which is reproduced in an enlarged view in FIG. 3B, multiple vector representations of the compound gene expression data are illustrated in proximity of a vector representation of disease gene expression data. The vector representations of the compound gene expression data include Midostaurin, daunorubicin, idarubicin, doxorubicin, and thioguanine, and the vector representation of disease gene expression data includes acute myeloid leukemia. The grouping of Midostaurin and such in proximity of acute myeloid leukemia may indicate that that the compounds represented by the compound gene expression data are likely effective in treating acute myeloid leukemia. Accordingly, treatment association predictions may be made based on the illustrated grouping based on distances separating the representation of acute myeloid leukemia from the various compound representations, and/or separating the compound representations from one another. It should be appreciated that intra-domain associations and other types of inter-domain associations may be grouped in the manner illustrated according to various domain and/or modality specific characteristics in the data, and predictions may be formed correspondingly.

Cluster 342a may be generated by first domain encoder 110a, second domain encoder 110b, and/or common space encoders 130a and 130b. For example, first domain encoder 110a may map the illustrated vector representations of the compound gene expression data together in first domain space 120a based on gene expression characteristic similarities. Alternatively or additionally, second domain encoder 110b may map the representation of acute myeloid leukemia to second domain space 120b based on its gene expression characteristics, and/or its similarity to training disease data having similar and/or differing gene expression characteristics. Common space encoders 130a and 130b may map the vector representations of the compound gene expression data and the disease gene expression data together based on an indication in the gene expression characteristics of each vector representation that they form an effective treatment association. In some cases, one or more of the compound vector representations, such as Midostaurin, may be used as training data, with others of the compound representations being grouped with Midostaurin by first domain encoder 110a. In the same or other cases, an additional disease representation that has a known treatment relationship with Midostaurin may be used to train common space encoder(s) 130a and/or 130b, and acute myeloid leukemia may be grouped with another disease representation (not shown) by second domain encoder 110b, resulting in the grouping of myeloid leukemia with Midostaurin and compounds determined to be similar to Midostaurin by first domain encoder 110a.

It should be appreciated that, although only a single modality for each domain is illustrated in FIGS. 3A-3B, multiple modalities and/or modalities other than gene expression data may be used to form clusters in the same or similar manner as illustrated in FIGS. 3A-3B. For example, the clusters illustrated in FIGS. 3A-3B may result from one first domain encoder 120a′ and one second domain encoder 120b′ of system 100c each mapping data from a single modality to domain- and modality-specific spaces, followed by common space encoders 130a′ and 130b′ mapping the data to common space 140′.

Moreover, in non-biological applications, clusters may be formed in the same or a similar manner as described for the biological example. For instance, in a traffic example, systems described herein may be adapted to form clusters of traffic condition data sharing common characteristics (e.g., accidents on winding roads involving SUVs), and/or to cluster such data together with traffic accident data (e.g., vehicles rolling over).

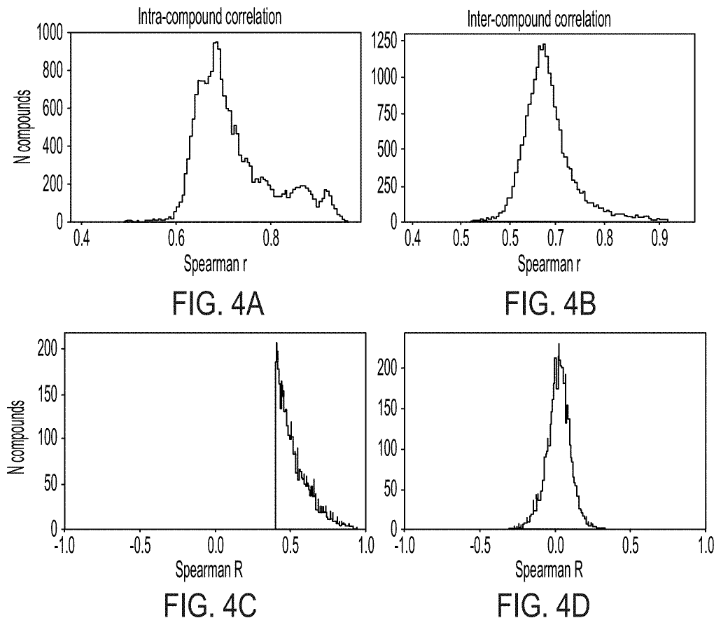

In some embodiments, methods described herein for predicting an association among data sets from multiple domains and/or multiple modalities within a domain (e.g., methods 200a, 200b) may further include applying signal conditioning to input data 102 to remove noise data. The inventors recognized that input data described herein may contain large quantities of noise data with a high degree of similarity, making it more difficult for first domain encoder 110a and/or second domain encoder 110b to perceive patterns in the input data. While the techniques for emphasis and de-emphasis of certain characteristics described herein may be sufficient for some applications, the inventors recognized that conditioning (e.g., filtering) the noise data may further improve the accuracy of association predictions generated by systems 100a, 100b, and/or 100c. In some embodiments, filtering input data 102 may include removing first and/or second domain data 104a and/or 104b having below a threshold level of self or intra-domain correlation. In a biological example described further herein including with reference to FIGS. 4A-4D, such correlation may include intra-compound and/or inter-compound correlation for compound data, or intra-disease and/or inter-disease correlation for disease data. While FIGS. 4A-4D illustrate data specific to compound gene expression data, it should be appreciated that techniques described herein for compound gene expression data may be adapted for other modalities within compound data such as compound chemical structure data, and/or for modalities of other domains such as diseases.

FIGS. 4A-4B illustrate intra-compound and inter-compound correlation, respectively, for exemplary compound gene expression data prior to noise conditioning, according to some embodiments. As illustrated in FIG. 4A, large quantities of intra-compound relationships show gene expression data with high intra-compound spearman correlation. For example, several r values between 0.6 to 0.8 have over 600 intra-compound relationships, with some showing over 900 intra-compound relationships. Likewise, as shown in FIG. 4B, large quantities of inter-compound relationships also show gene expression data with high inter-compound spearman correlation, with some r values between 0.6 and 0.7 showing more than 1000 inter-compound relationships each. The inventors recognized that such high numbers of intra-compound and inter-compound relationships with significantly high correlation can result in gene expression noise levels that impact the accuracy of predictions.

FIGS. 4C-4D illustrate intra-compound and inter-compound correlation, respectively, for the compound gene expression data of FIG. 4A after noise conditioning, according to some embodiments. The results show the impact of signal conditioning in which gene expression data having below a threshold level of intra-compound correlation are removed (e.g., filtered) from the data set. For example, as shown in the illustrated embodiment of FIG. 4C, gene expression data having below about spearman r=0.4 remains following filtering. Accordingly, just over 200 intra-compound relationships constitute the most common spearman r level at about r=0.4. Likewise for FIG. 4D, the most common inter-compound relationship spearman r has less than 250 relationships around r=0. The inventors found that, with a smaller number of more correlated compounds, noise data may be reduced to facilitate more accurate association predictions.

It should be appreciated that noise data may be present in other applications, and noise conditioning techniques may be applicable in the same or a similar manner to such applications (e.g., traffic accident prediction, financial market event prediction, etc.) to improve association prediction accuracy.

FIG. 5A is a flow diagram of exemplary method 500a for training an encoder (e.g., first domain encoder 110a, second domain encoder 110b, etc.) to predict associations among input data using an energy metric, according to some embodiments. Method 500a includes mapping input data 102 to a representation space (e.g., first domain space 120a, second domain space 120b, etc.) at step 502a, calculating an energy metric at step 504a, and adjusting encoder parameters at step 506a.

Mapping input data 102 to the representation space at step 502a may include applying a weighted transform to input data 102 input to the encoder. For example, in some embodiments, the weighted transform may be of the form:

Z=α(WₑX+bₑ) (1)

where Z is the transform of input data X, α is an activation function, and Wₑ and bₑ represent linear weights. Wₑ and bₑ may have different values for different dimensional components of input data X, resulting in weighted transform of the components in generating transform Z. In some embodiments, the activation function α may be a non-linear activation function, such as a scaled exponential linear unit (SeLu), rectified linear unit (ReLu), exponential linear unit (ELU), or leaky ReLu activation function. In some embodiments, the weighted transform may map input data 102 to a hyper-geometric space. For example, transform Z may map to a hyper-geometric surface constituting the vector space (e.g., first domain space 120a, second domain space 120b, etc.). In some embodiments, the input data provided to the encoder may be training data.

Calculating the energy metric at step 504a may be based on a distance separating a data set (e.g., pair) taken from the input data. For example, the distance may change the impact of the energy metric on weights and biases of the encoder, with increasing distance among similar data resulting in an increased impact of the energy metric, resulting in more significant adjustments to encoder parameters at step 506a. Likewise, increasing distance among different data may result in a decreased impact of the energy metric, resulting in smaller adjustments to the encoder parameters. In some embodiments, the energy metric may be a term which increases in size as the distance increases (e.g., for similar data) or decreases (e.g., for different data).

In response to calculating the energy metric at step 504a, the encoder parameters may be adjusted at step 506a, which may include adjusting weights and/or biases of the encoder. For example, Wₑ and bₑ for some or all vector components may be adjusted in an amount determined by the impact (e.g., size) of the energy metric.

FIG. 5B is a flow diagram of exemplary method 500b for training an encoder to predict associations among input data using an energy metric, according to some embodiments. Method 500b includes labeling sets of input data at step 502b, mapping the input data to a space at step 504b, calculating an energy metric at step 506b, calculating a loss function using the energy metric at step 508b, and adjusting encoder parameters.

Labeling sets of input data at step 502b may include providing training data to the encoder that is known to have similar characteristics, and/or different characteristics, in order to emphasize and/or de-emphasize the similar and/or different characteristics during training. In a biological example, a gene expression characteristic of a group of compounds may tie the group of compounds together in terms of treatment efficacy despite the group of compounds sharing few other biological characteristics. Accordingly, in some embodiments, the group of compounds (or at least two members of the group) may be provided to the encoder as training inputs labeled as similar. As a result, the energy metric and loss function which may be calculated at steps 506b and 508b may cause the encoder to adjust weights and/or biases to emphasize recognition of the particular gene expression characteristic, or other biological characteristic(s) suitable for the modality or modalities in use, which ties the group together. The inventors recognized that such subtle differences as described in the present example may be overlooked when unsupervised machine learning techniques are employed alone. Embodiments according to the present example may address this issue by providing the labels (e.g., similar, different, etc.) to the energy metric such that the encoder may be trained to position input data labeled as similar close to one another, and likewise, to position input data labeled as different far from one another, as described further herein. Following labeling at step 502b, mapping the input data to a representation space (e.g., hyper-geometric space) in step 504b may be performed in the manner described for step 502a in connection with FIG. 5A.

In some applications, use of data labels in training may facilitate biomarker identification. For example, an encoder may be trained to associate biological data taken from patients who responded to a particular treatment (e.g., a compound) with the treatment. Likewise, the encoder may be trained to disassociate biological data from patients who did not respond to the treatment from the treatment. Accordingly, encoders may be trained to associate new patient data (e.g., not used in training) with treatments that were effective on similar patients (e.g., used in training), and to disassociate the new patient data from treatments that were not effective on such patients. In doing so, the encoders may determine whether the new patient will respond to the treatment based on biological data extracted from the new patient and input to the encoder.

As in step 504a of FIG. 5A, calculating the energy metric at step 506b may use a distance separating a data set taken from the input data. Moreover, in some embodiments, training data provided as input to the encoder may be labeled, and the energy metric may depend on the labels provided to the input data at step 502b. In the biological example, compound gene expression data for two compounds may be input during training with a label as similar, and so the encoder may be penalized for positioning the two compounds far apart. Accordingly, in some embodiments, calculating the energy metric may be part of calculating a loss function to determine how much to penalize the encoder for a particular output. In some embodiments, the energy metric may include a continuous function that increases as the distance separating the representations of the compounds increases. In some embodiments, the loss function may also include terms for weights and biases of the encoder, such as Wₑ and bₑ referenced above. In a first example, the loss function may be of the form:

$$L = \vert \hat{y} - y \vert + {e}^{- k d ( X , Xn )} + {e}^{\frac{nd ( X , Xp )}{k}} + β \sum θ \qquad ( 2 A )$$

where |ŷ−y| indicates the K1 decoding loss from the outputs versus the inputs (e.g., due to reduced dimensionality), d(A,B) is the distance measured between each vector component of A and B (e.g., cosine distance), X is the K2 norm of the encoder's bottleneck layer, Xₙ is a vector representation of input data labeled as different to X, Xₚ is a vector representation of input data labeled as similar to X, k is a parameter related to (e.g., a hyper-parameter for controlling) the shape of the energy metric, n is a normalization constant which may be equal to

$${k}^{*} \frac{ln ( 2 )}{2} ,$$

β is a regularization hyper-parameter, and Σθ is a sum of absolute magnitudes of all weights. It should be appreciated that some embodiments may set normalization constant n=1, as normalization may not be desirable in such embodiments. Accordingly, calculating the loss function at step 508b typically occurs following calculation of the energy metric at step 506b, with adjusting encoder parameters at step 510b taking place following calculation of the loss function.

In equation (2A), the energy metric includes the terms

$${e}^{- k d ( X , Xn )} + {e}^{\frac{n d ( X , Xp )}{k}} .$$

For instance, the exponential functions of the term are continuous functions that continuously adjust the impact of the energy metric on the loss function L as the distances d(X,Xₙ) and d(X,Xₚ) change. In an example, the encoder may adjust its weights and biases to reduce (e.g., minimize) the term e^{-kd(X,Xn)} at least in part by increasing (e.g., maximizing) the distance d(X,Xₙ), because when distance is small, the impact of this portion of the energy metric is large. Accordingly, the encoder may be rewarded for increasing the distance separating X from Xₙ, labeled as different from X. As another example, the encoder may adjust its weights and biases to reduce (e.g., minimize) the term

$${e}^{\frac{n d ( X , Xp )}{k}}$$

by decreasing (e.g., minimizing) the distance d(X,Xₚ), as when the distance is large, the impact of this portion of the energy metric is large. Accordingly, the encoder may also be rewarded for decreasing the distance separating X from Xₚ, labeled as similar to X.

In a second example, the loss function may be of the form:

$$L = \vert \hat{y} - y \vert + 1 - \frac{1}{1 + {e}^{- k ( d ( X , Xn - 1 ) )}} + \frac{1}{1 + {e}^{- k ( d ( X , Xp - 1 ) )}} + β Σ θ \qquad ( 2 B )$$

where the energy metric may include the terms

$$1 - \frac{1}{1 + {e}^{- k ( d ( X , Xn - 1 ) )}} + \frac{1}{1 + {e}^{- k ( d ( X , Xp - 1 ) )}} .$$

As in the first example, the encoder may adjust its weights and biases to reduce the term

$$1 - \frac{1}{1 + {e}^{- k ( d ( X , Xn - 1 ) )}}$$

at least in part by increasing the distance d(X,Xₙ). The encoder may also adjust its weights and biases to reduce the term

$$\frac{1}{1 + {e}^{- k ( d ( X , Xp - 1 ) )}}$$

by decreasing the distance d(X,Xₚ).

In a third example, the loss function may be of the form:

$$L = \vert \hat{y} - y \vert + ln ( \frac{2 + k}{k} ) - ln ( \frac{d ( X , Xn ) + k}{k} ) + ln ( \frac{d ( X , Xp ) + k}{k} ) + β Σ θ \qquad ( 2 C )$$

In a fourth example, the loss function may be of the form:

$$L = \vert \hat{y} - y \vert + \{ \begin{matrix}0 , & 2 - d ( X , Xn ) - k \leq 0 \\ s * ( 2 - d ( X , Xn ) - k ) , & else\end{matrix} + \{ \begin{matrix}0 , & d ( X , Xn ) - k \leq 0 \\ s * ( d ( X , Xp ) - k ) , & else\end{matrix} + β \sum θ \qquad ( 2 D )$$

where the energy metric may include the terms

$$\{ \begin{matrix}0 , & 2 - d ( X , Xn ) - k \leq 0 \\ s * ( 2 - d ( X , Xn ) - k ) , & else\end{matrix} + \{ \begin{matrix}0 , & d ( X , Xn ) - k \leq 0 \\ s * ( d ( X , Xp ) - k ) , & else\end{matrix} .$$

As in the previous examples, the encoder may adjust its weights and biases to reduce (e.g., minimize) the term

$$\{ \begin{matrix}0 , & 2 - d ( X , Xn ) - k \leq 0 \\ s * ( 2 - d ( X , Xn ) - k ) , & else\end{matrix}$$

at least in part by increasing the distance d(X,Xₙ). The encoder may also adjust its weights and biases to reduce the term

$$\{ \begin{matrix}0 , & d ( X , Xn ) - k \leq 0 \\ s * ( d ( X , Xp ) - k ) , & else\end{matrix}$$

by decreasing the distance d(X,Xₚ). Thus, an energy metric may provide aspects of supervised machine learning when training an unsupervised encoder.

Adjusting encoder parameters at step 510b may include adjusting weights and/or biases of the encoder using distances used to calculate the energy metric. For example, linear and/or non-linear weights (e.g., for various vector components) may be adjusted in attempt to reduce the penalty incurred from the loss function calculated at step 508b, and/or to reduce the impact of the energy metric on the loss function. In some embodiments, weights corresponding to vector components that represent particular data characteristics may be adjusted based on the loss function and/or energy metric, so as to emphasize and/or de-emphasize some data characteristics in the mapping.

FIG. 6A is a flow diagram of exemplary method 600a for training an encoder (e.g., common space encoder 130a and/or 130b, etc.) to predict associations among input data from multiple domains (e.g., compound and disease data), according to some embodiments. Method 600a includes mapping input data to a common space 140 (e.g., common space 140) at step 602a, calculating an energy metric at step 604a, and adjusting encoder parameters at step 606a.

Mapping input data to the common space at step 602a may include applying a weighted transform to encoded first or second domain data 104a and/or 104b. For example, the weighted transform may be of the form:

hₙ=g(hₙ₋₁W) (3)

Where h₀ takes on values of vector representations of encoded first and second domain data 104a and/or 104b, W is a model weight vector, go is the selu non-linearity, and n is the number of layers in the model. The output h_{N} of embedding layers of the encoder may be K2-normed. In some embodiments, the transform h may result in a hyper-geometric surface, constituting the common space. In some embodiments, the encoded input data provided to common space encoders 130a and/or 130b may be training data.

Calculating the energy metric at step 604a may be based on a distance separating a data set taken from the input data. For example, the distance may change the impact of the energy metric on weights and biases of the encoder, with increasing distance separating a strongly-associated pair resulting in an increased impact of the energy metric, resulting in more significant adjustments to encoder parameters. Likewise, increasing distance separating a non-associated pair may result in a decreased impact of the energy metric, resulting in smaller adjustment to encoder parameters. In some embodiments, the energy metric may be a term which increases in size as the distance increases (e.g., for associated data) or decreases (e.g., for non-associated data).

In response to calculating the energy metric at step 604a, the parameters of the encoder may be adjusted at step 506a, which may include adjusting weights and/or biases of the encoder. For example, W for some or all vector components may be adjusted in an amount determined by the impact (e.g., size) of the energy metric.

FIG. 6B is a flow diagram of exemplary method 600b for training an encoder to predict associations among input data, according to some embodiments. Method 600b includes initializing one or more common space encoders (e.g., common space encoders 130a and 130b) at step 602b, labeling sets of encoded input data (e.g., pairs of encoded first and second domain data 104a and 104b) at step 604b, mapping the input data (e.g., the labeled pairs and/or other portions of encoded first and/or second domain data 104a and/or 104b) to a common space at step 606b, calculating an energy metric at step 608b, calculating a loss function using the energy metric at step 610b, and adjusting encoder parameters at step 612b.

Initializing the common space encoder(s) at step 602b may include a preliminary mapping of input data to the common space. In some embodiments, the preliminary mapping may be based on labeling of a pair (e.g., associated, not associated) among encoded first and second domain data 104a and 104b. In some embodiments, the labeling of the pair may not be taken into consideration when preliminarily mapping. In a biological example, the preliminary mapping may be a spatially uniform distribution of gene expression data. In some embodiments, a loss function may be employed to penalize the encoder for non-uniform distribution of input data in the common space. For example, the loss function may be of the form:

L=−[d(Cᵢ,Dⱼ)+d(Cₙ,Dₙ)+d(Cₚ,Dₚ)] (4A)

where Cᵢ,Cⱼ represent pairwise combinations between input data vector representations of a first domain (e.g., compounds), Cₙ,Dₙ represent input data pairs from multiple domains (e.g., compound and disease) that are not known to have any relationship and Cₚ,Dₚ are input data pairs from multiple domains known to have a relationship (e.g., FDA approved treatment relationship). Accordingly, the preliminary mapping followed by calculation of the loss function may result in a spatially uniform distribution of the input data vector representations. The inventors found that, in some cases, such initialization may increase the accuracy of association predictions made using trained encoders employing techniques described herein. In an alternative example, the loss function may omit the latter terms, resulting in the form:

L=−d(Ci,Dj) (4B)

Labeling pairs of input data at step 604b may include providing training data to the encoder that are known to have an association, and/or no known treatment association, in order to emphasize and/or de-emphasize some characteristics of each association during training. In a biological example, compound gene expression data and disease gene expression data may represent a compound and a disease having a known treatment association despite some gene expression characteristics which may indicate a lack of association, and a label indicating similarity may be based on the known association. As a result, in this example, the energy metric and loss function which may be calculated at steps 608b and 610b may cause the encoder to adjust weights and/or biases at step 612b to emphasize recognition of the particular gene expression characteristic(s) which underlie the association or lack thereof. The inventors recognized that such subtle indications of association as described in the present example may be overlooked when unsupervised machine learning techniques are employed alone. Embodiments according to the present example may address this issue by providing the labels (e.g., treatment pair, non-treatment pair, etc.) to the energy metric such that the encoder may be trained to position input data labeled as having an association close to one another, and likewise, to position input data labeled as having no known association far from one another, as described further herein. Following labeling at step 604b, mapping the input data to the common space in step 606b may be performed in the manner described for step 602a in connection with FIG. 6A.

As in step 604a of FIG. 6A, calculating the energy metric at step 608b may be based on a distance separating a data set taken from the input data. Moreover, in some embodiments, training data provided as input to the encoder may be labeled, and the energy metric may depend on the labels provided to the input data at step 604b. In a biological example, compound gene expression data for a compound and disease gene expression data for a disease may be input during training with a label as a treatment pair, and so the encoder may be penalized for positioning the pair far apart in the common space. Accordingly, in some embodiments, calculating the energy metric may be part of calculating a loss function to determine how much to penalize the encoder for a particular output. In some embodiments, the energy metric may include a continuous function that increases as the distance separating the representations of the compound and the disease increases. In some embodiments, the loss function may also include terms for weights and biases of the encoder, such as W referenced above. In one example, the loss function may be of the form:

L=(e^{-kd(Cn,Dn)}+e^{nd(Cp,Dp)/k})+βΣθ (5)

Accordingly, calculating the loss function at step 610b typically occurs following calculation of the energy metric at step 608b, with adjusting encoder parameters at step 612b taking place following calculation of the loss function. In equation (4), the term (e^{-kd(Cn,Dn)}+e^{nd(Cp,Dp)/k}) may include the energy metric. For instance, the exponential functions of the term are continuous functions, facilitating continuously adjusting the impact of the energy metric on the loss function L as the distances d(Cₙ,Dₙ) and d(Cₚ,Dₚ) change. In an example, the encoder may adjust its weights and biases to reduce (e.g., minimize) the term e^{-kd(Cn,Dn)} at least in part by increasing (e.g., maximizing) the distance d(Cₙ,Dₙ), because when distance is small, the impact of this portion of the energy metric is large. Accordingly, the encoder may be rewarded for increasing the distance separating Cₙ from Dₙ, labeled as having no known treatment association with Cₙ. As another example, the encoder may adjust its weights and biases to reduce (e.g., minimize) the term e^{nd(Cp,Dp)/k} by decreasing (e.g., minimizing) the distance d(Cₚ,Dₚ), as when the distance is large, the impact of this portion of the energy metric is large. Accordingly, the encoder may also be rewarded for decreasing the distance separating Cₚ from Dₚ, labeled as having a known treatment association with Cₚ. Thus, an energy metric may be used to provide aspects of supervised machine learning when training an unsupervised encoder. It should be appreciated that the loss functions of equations 2B-2D may also be adapted for use in training one or more common space encoders.

Adjusting encoder parameters at step 612b may include adjusting weights and/or biases of the encoder based on distances used to calculate the energy metric. For example, linear and/or non-linear weights (e.g., for various vector components) may be adjusted in attempt to reduce the penalty incurred from the loss function calculated at step 610b, and/or to reduce the impact of the energy metric on the loss function. In a biological example, weights corresponding to vector components (e.g., of W) that represent particular gene expression characteristics may be adjusted based on the loss function and/or energy metric, so as to emphasize and/or de-emphasize some gene expression characteristics in the mapping.

It should be appreciated that techniques and equations described herein including in connection with FIGS. 5A-6B may be adapted for use in other applications. For instance, transform functions described herein may be used to encode input data of various types. Likewise, loss functions described herein may be employed during training to enforce labeled associations among input data. In an exemplary system that predicts associations among movie data as a first domain and consumer data as a second domain, encoders of the system may be trained using data that includes movie-movie (e.g., labeling an association among movies about dogs, etc.), consumer-consumer (e.g., labeling consumer data for families having young children, etc.), and/or movie-consumer pairings (e.g., labeling data for an animated movie known to be popular with families having young children to be associated with that demographic, etc.). In this example, the same or similar loss functions may be employed to train the encoders to form intra-domain associations (e.g., associate animated comedies involving dogs) and/or to form inter-domain associations (e.g., associate movies involving dogs with families having young children). Accordingly, certain characteristics of movie and/or consumer data may be emphasized or de-emphasized during training.

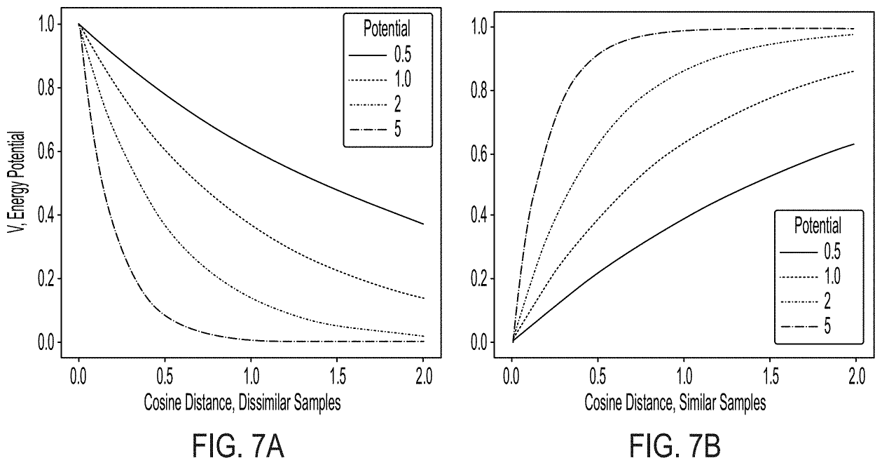

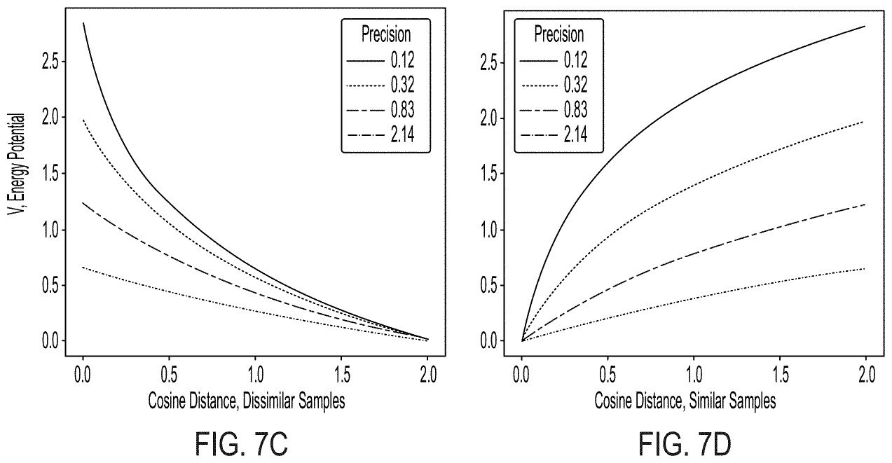

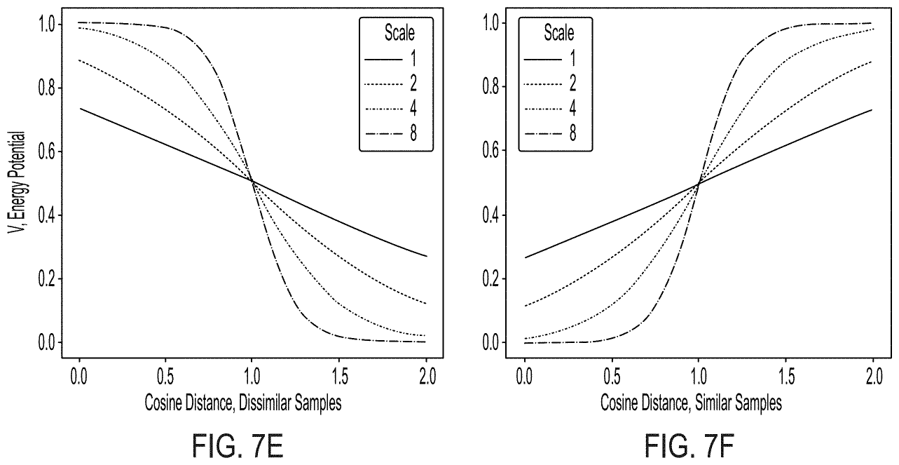

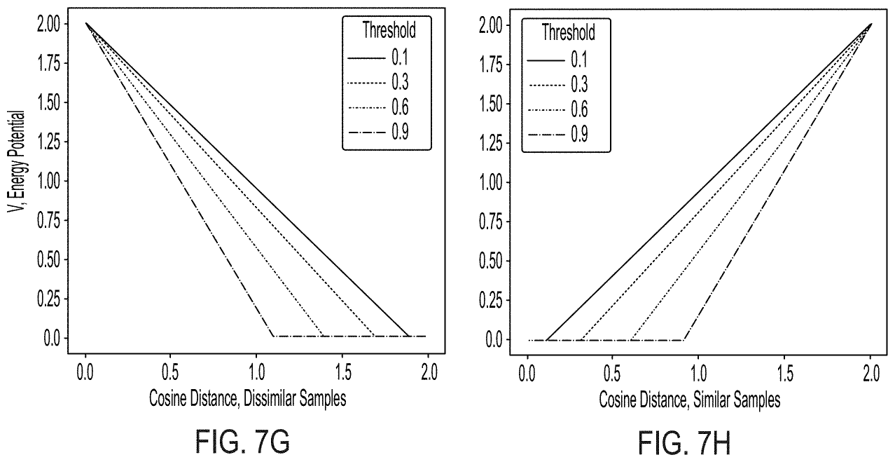

FIGS. 7A-7H illustrate energy decay of similar and dissimilar data generated using loss functions incorporating various energy metrics. Given a loss function with energy potentials as shown in FIGS. 7A-7H, an encoder may adjust its parameters to increase or decrease cosine distances separating data labeled as dissimilar or similar in order to reduce (e.g., minimize) the loss function.

FIG. 7A is a graph illustrating energy decay of data labeled as dissimilar, generated using an exponential energy metric, according to some embodiments. For instance, the energy decay illustrated in FIG. 7A may result from the loss function in equation (2A). FIG. 7B is a graph illustrating exponential energy decay of data labeled as similar, which may be generated using the same loss function as the data in FIG. 7A. As shown in FIG. 7A, energy potential is higher for dissimilar data separated by a smaller cosine distance, whereas energy potential is lower for a larger cosine distance. When an encoder works to reduce the loss function, the encoder may adjust parameters to increase the cosine distance separating the dissimilar data to reduce the energy potential in the loss function. Likewise, in FIG. 7B, energy potential increases as the cosine distance increases, so an encoder working to reduce the loss function may adjust parameters to decrease the cosine distance separating the similar data to reduce the energy potential in the loss function.

FIG. 7C is a graph illustrating energy decay of data labeled as dissimilar, generated using a logarithmic energy metric, according to some embodiments. For instance, the energy decay illustrated in FIG. 7C may result from the loss function in equation (2B). FIG. 7D is a graph illustrating logarithmic energy decay of data labeled as similar, which may be generated using the same loss function as the data in FIG. 7A.

FIG. 7E is a graph illustrating energy decay of data labeled as dissimilar, generated using a sigmoidal energy metric, according to some embodiments. For instance, the energy decay illustrated in FIG. 7E may result from the loss function in equation (2C). FIG. 7F is a graph illustrating sigmoidal energy decay of data labeled as similar, which may be generated using the same loss function as the data in FIG. 7E.

FIG. 7G is a graph illustrating energy decay of data labeled as dissimilar, generated using a rectified energy metric, according to some embodiments. For instance, the energy decay illustrated in FIG. 7G may result from the loss function in equation (2D). FIG. 7H is a graph illustrating rectified energy decay of data labeled as similar, which may be generated using the same loss function as the data in FIG. 7G.

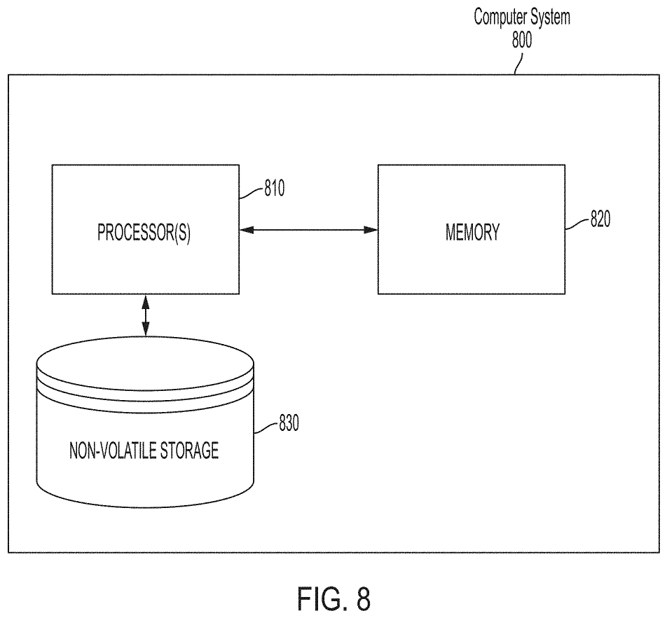

FIG. 8 is a diagram of an exemplary computer system 800 for application of some techniques described herein, according to some embodiments. The computer system 800 may include one or more computer hardware processors 810 and one or more articles of manufacture that comprise non-transitory computer-readable storage media (e.g., memory 820 and one or more non-volatile storage devices 830). The processor 810(s) may control writing data to and reading data from the memory 820 and the non-volatile storage device(s) 830 in any suitable manner. To perform any of the functionality described herein, the processor(s) 810 may execute one or more processor-executable instructions stored in one or more non-transitory computer-readable storage media (e.g., the memory 820), which may serve as non-transitory computer-readable storage media storing processor-executable instructions for execution by the processor(s) 810.

In some embodiments, computer system 800 may provide a user interface configured to receive at least a portion of input data 102 and to generate, responsive to receiving input data 102, association predictions 160. For example, a healthcare professional and/or researcher may input portions of input data 102 for one or more domains (e.g., compounds and/or diseases), resulting in an association prediction as to whether the input biological data is included in any treatment relationships. In some embodiments, the processor(s) 810 may include a graphical processing unit (GPU) configured to generate the user interface on one or more display screens. In some embodiments, the processor(s) 810 may be coupled to a user input device such as a mouse and/or keyboard for receiving user input (e.g., biological information 102). In some embodiments, the memory 820 may store input data 102 for encoding, comparing, and/or matching, etc., locally on the processor(s) 810. In some embodiments, the processor(s) 810 may further include a network controller for connecting to a communication network (e.g., the Internet) to obtain other portions of input data 102 for encoding, comparing, and/or matching to the portions of input data 102 input by the user. In some embodiments, the encoding, comparison, and/or matching may be performed on a remote computer system (e.g., centralized server, distributed computing system) coupled to computer system 800 over the communication network.

Computer system 800 may be configured for other applications, as described further herein. Systems in accordance with each example may include a user interface configured to receive data from a user and to provide prediction results for user consumption. Moreover, each example may be configured in accordance with systems and methods described herein.

In a first example, computer system 800 may be configured to predict the level of security present in a computing network by assessing the likelihood of intrusion, theft, and/or network disruption given network conditions. In this example, network condition data, such as detachable hardware location data, network structure data, network traffic data, and/or user behavior data, may be input to system 800. System 800 may be configured to associate the network condition data with network event data, such as intrusion, theft, network disruption, and/or the like. In some embodiments, encoders of the system may be trained to associate particular network condition data and/or network event data with one another to predict new associations among new and/or existing condition and event data.

In a second example, computer system 800 may be configured to predict financial market events (e.g., market crash, etc.) by assessing the likelihood of such events given market conditions. In this example, market condition data, such as relative prices of various commodities, upward or downward trends (e.g., general and/or in specific parts of the market), and/or gross domestic product may be input to system 800. System 800 may be configured to associate System 800 may be further configured to associate the market condition data with market event data, such as crashes, booms, and/or the like. In some embodiments, encoders of the system may be trained to associate particular market condition data and/or market event data with one another to predict new associations as the market progresses in time.

In a third example, computer system 800 may be configured to predict traffic accidents by assessing the likelihood of such accidents given traffic conditions. In this example, traffic condition data, such as the number and/or type of cars, the number of lanes on the road, the time of year, and/or the geographic location may be input to system 800. System 800 may be configured to form associations within the traffic condition or traffic event data (e.g., associating a high number of cars with a particular time of year). System 800 may be further configured to associate the traffic condition data with certain traffic accident data, such as multi-car accidents, merging accidents, and/or head-on collision accidents. In some embodiments, encoders of the system may be trained to associate particular traffic condition data and/or traffic accident data with one another to predict new associations, such as for new or modified roads and/or intersections.

In a fourth example, computer system 800 may be configured to predict whether features in images or videos are real or “deep fakes” produced using machine learning. In this example, some videos or images known to be real (e.g., an official news broadcast) may be input to system 800, and the system may be configured to associate various real videos or images with one another based on perceived characteristics. System 800 may be further configured to associate certain fake videos or images with one another based on characteristics of the fake videos or images. Accordingly, new videos or images, not yet known whether real or fake, may be input to system 800, and the system may associate the videos or images with known real or fake images based on perceived characteristics to predict whether the videos or images are indeed real or fake.

In a fifth example, computer system 800 may be configured to predict whether a system user and/or a group of consumers will want to see a new movie. In this example, movie data and user or consumer data may be input to system 800. Based on labeled associations during training (e.g., associating a user with a movie the user was known to have liked, associating two users with similar preferences), system 800 may predict new associations, such as whether a new user will want to see an existing movie, or whether an existing user will want to see a new movie.

In a sixth example, computer system 800 may be configured to predict a political event given social media data. In this example, social media data may be input to computer system 800, which may have been trained to associate known major political events (e.g., “Arab Spring”) with certain social media trends, and/or to associate types of political events or social media trends with one another. Accordingly, system 800 may be configured to predict new political events when certain social media trends occur.

In a seventh example, computer system 800 may be configured to predict a natural disaster given human and/or environmental condition data. In this example, human population, human activity, and/or environmental data may be input to system 800, which may be trained to form certain associations among the input. System 800 may further associate the input data with natural disaster data to predict how likely a disaster is to occur given the input data. Accordingly, system 800 may be configured to predict future natural disasters given current human and/or environmental conditions.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of predicting an association among input data, comprising:
mapping, by at least one processor, the input data to at least one space;
calculating, by the at least one processor, an energy metric based on a distance, in the at least one space, separating members of a data pair of the input data; and
predicting, by the at least one processor based on the energy metric, that the members of the data pair are associated with one another.

2. The method of claim 1, wherein calculating the energy metric includes calculating an exponential term.

3. The method of claim 1, wherein calculating the energy metric includes calculating at least one term selected from a group consisting of:
an exponential term;
a logarithmic term;
a sigmoidal term; and
a continuous piecewise linear term.

4. The method of claim 1, wherein mapping the input data to the at least one space includes grouping vector representations of the input data into a plurality of clusters in the at least one space.

5. The method of claim 1, wherein the at least one space includes a hyper-geometric space.

6. The method of claim 5, wherein the hyper-geometric space includes a surface of a hypersphere.

7. The method of claim 5, wherein calculating the energy metric includes using a hyper-parameter of the hyper-geometric space.

8. The method of claim 1, wherein predicting that the members of the data pair are associated with one another includes determining, based on the energy metric, a likelihood that the members of the data pair are associated with one another.

9. The method of claim 1, further comprising filtering out, by the at least one processor, portions of the input data having less than a threshold level of correlation prior to mapping the input data to the at least one space.

10. (canceled)

11. The method of claim 1, wherein the members of the data pair are of a same data domain.

12. The method of claim 11, wherein a first member of the data pair is of a first data modality within the same data domain, and a second member of the data pair is of a second data modality within the same data domain.

13. The method of claim 12, wherein mapping the input data to the at least one space includes:
mapping the first member of the data pair to a first modality space; and
mapping the second member of the data pair to a second modality space.

14. The method of claim 11, wherein the same data domain is compounds, and the first and second data modalities are selected from a group consisting of:
compound gene expression data;
compound chemical structure data;
compound target data; and
compound side-effect data.

15. The method of claim 12, wherein the same data domain is diseases, and the first and second data modalities are selected from a group consisting of:
disease gene expression data;
disease symptom data; and
disease biological pathway data.

16. The method of claim 1, wherein first and second members of the data pair are of respective first and second domains.

17. The method of claim 16, wherein mapping the input data to the at least one space includes:
mapping the first member of the data pair to a first domain space; and
mapping the second member of the data pair to a second domain space.

18. The method of claim 17, wherein mapping the input data to the at least one space further includes:
mapping the first member of the data pair to a first modality space of the first domain; and
mapping the second member of the data pair to a first modality space of the second domain.

19. The method of claim 16, wherein the first and second domains are compounds and diseases, respectively.

20-195. (canceled)

196. A system for predicting an association among input data, comprising:
at least one trained encoder configured to:
map the input data to at least one space; and
calculate an energy metric relating to the map; and
at least one decoder configured to output a prediction, generated using the energy metric, associating members of a data pair of the input data.

197. The system of claim 196, further comprising at least one processor configured to execute the at least one trained encoder.

198. The system of claim 197, wherein the at least one processor is configured to generate the energy metric using a distance, in the at least one space, separating the members of the data pair.

199. The system of claim 196, wherein the energy metric includes an exponential term.

200. The system of claim 196, wherein the energy metric includes at least one term selected from a group consisting of:
an exponential term;
a logarithmic term;
a sigmoidal term; and
a continuous piecewise linear term.

201. The system of claim 197, wherein the at least one trained encoder is configured to group vector representations of the input data into a plurality of clusters in the at least one space.

202. The system of claim 197, wherein the at least one space includes a hyper-geometric space.

203. The system of claim 202, wherein the hyper-geometric space includes a surface of a hypersphere.

204. The system of claim 202, wherein the at least one processor is further configured to calculate the energy metric using a hyper-parameter of the hyper-geometric space.

205. The system of claim 197, wherein the at least one processor is configured to predict that the members of the data pair are associated with one another at least in part by determining, using the energy metric, a likelihood that the members of the data pair are associated with one another.

206. The system of claim 197, wherein the at least one processor is further configured to filter out portions of the input data having less than a threshold level of correlation prior to mapping the input data to the at least one space.

207. (canceled)

208. The system of claim 197, wherein the members of the data pair are of a same data domain.

209. The system of claim 208, wherein a first member of the data pair is of a first data modality within the same data domain, and a second member of the data pair is of a second data modality within the same data domain.

210. The system of claim 209, wherein the at least one trained encoder includes:
a first modality encoder configured to map the first member of the data pair to a first modality space; and
a second modality encoder configured to map the second member of the data pair to a second modality space.

211. The system of claim 209, wherein the same data domain is compounds, and the first and second data modalities are selected from a group consisting of:
compound gene expression data;
compound chemical structure data;
compound target data; and
compound side-effect data.

212. The system of claim 209, wherein the same data domain is diseases, and the first and second data modalities are selected from a group consisting of:
disease gene expression data;
disease symptom data; and
disease biological pathway data.

213. The system of claim 197, wherein first and second members of the data pair are of respective first and second domains.

214. The system of claim 213, wherein the at least one trained encoder includes:
at least one first domain encoder configured to map the first member of the data pair to a first domain space; and
at least one second domain encoder configured to map the second member of the data pair to a second domain space.

215. The system of claim 214, wherein:
the at least one first domain encoder includes a first modality encoder configured to map the first member of the data pair to a first modality space of the first domain; and
the at least one second domain encoder includes a second modality encoder configured to map the second member of the data pair to a second modality space of the second domain.

216. The system of claim 213, wherein the first and second domains are compounds and diseases, respectively.

217-223. (canceled)

224. The system of claim 197, further comprising a user interface component coupled to the at least one processor, wherein the user interface component is configured to receive at least a first portion of the input data from a user.

225. The system of claim 224, wherein the user interface component includes at least one member selected from a group consisting of:
a mouse;
a keyboard;
a touchscreen; and
a microphone.

226. The system of claim 197, further comprising a network interface component coupled to the at least one processor, wherein the network interface component is configured to receive at least a second portion of the input data over a communication network.

227-297. (canceled)

298. A non-transitory computer-readable medium having encoded thereon instructions that, when executed by at least one processor, cause the at least one processor to perform a method, the method comprising:
mapping, by the at least one processor, the input data to at least one space;
calculating, by the at least one processor, an energy metric based on a distance, in the at least one space, separating members of a data pair of the input data; and
predicting, by the at least one processor based on the energy metric, that the members of the data pair are associated with one another.
